(19) United States
(12) Patent Application Publication
(10) Pub. No.: US 2002/0192383 A1
(43) Pub. Date: Dec. 19, 2002

(54) Methods for preparing fluid diffusion layers and electrodes using compaction rollers

(76) Inventors: David Kar Ling Lo, Vancouver (CA); Joachim Schaefer, Vancouver (CA); Harald Tober, Boblingen (DE); Nicola Simon, Vancouver (CA)

Correspondence Address: Robert W. Fieseler, McAndrews, Held & Malloy, Ltd., 500 West Madison Street, 34th Floor, Chicago, IL, 60661, US

(21) Appl. No.: 09/872,311

(22) Filed: May 31, 2001

(51) Int. Cl. B05D 3/12; B05D 3/02

(52) U.S. Cl. 427/359; 427/372.2

(57) ABSTRACT

Methods of preparing a fluid diffusion layer comprise continuously applying a loading material to a substrate and continuous compacting the substrate and loading material applied thereto with at least one compaction roller. Methods of preparing an electrode comprise continuously applying an electrocatalyst to a fluid diffusion layer and continuously compacting the fluid diffusion layer and electrocatalyst applied thereto with at least one compaction roller. The methods can be employed in a continuous process and can increase the penetration and adhesion of the loading material.

### FIELD OF THE INVENTION

The present invention relates to improved methods for making fluid diffusion layers and electrodes for electrochemical cells such as solid polymer electrolyte fuel cells. In methods for preparing fluid diffusion layers, one or more loading materials are applied to a porous substrate and compacted using at least one compaction roller in a continuous process. In methods for preparing fluid diffusion electrodes, one or more electrocatalysts are applied to a fluid diffusion layer and compacted using at least one compaction roller in a continuous process.

### BACKGROUND OF THE INVENTION

Electrochemical fuel cells convert fuel and oxidant to electricity and reaction product. Solid polymer electrolyte fuel cells generally employ a membrane electrode assembly (“MEA”) comprising a solid polymer electrolyte or ion exchange membrane disposed between two electrically conductive electrodes. The electrodes typically comprise a fluid diffusion layer and an electrocatalyst. The fluid diffusion layer comprises a substrate with a porous structure having voids therein. The substrate is permeable to fluid reactants and products in the fuel cell. Fluid reactants may be supplied to the electrodes in either gaseous or liquid form. The electrocatalyst is typically disposed in a layer at each membrane/electrode interface, to induce the desired electrochemical reaction in the fuel cell. However, the electrocatalyst may be disposed as a layer on the electrode or the ion exchange membrane, or it may be part of the electrode in some other way. The electrodes are electrically coupled to provide a path for conducting electrons between the electrodes through an external load.

Materials commonly used as substrates or as starting materials to form substrates include carbon fiber paper, woven and nonwoven carbon fabrics, metal mesh or gauze, and other woven and nonwoven materials. Such materials are commercially available in flat sheets and, when the material is sufficiently flexible, in rolls. Substrate materials tend to be highly electrically conductive and macroporous fluid diffusion layers may also contain a particulate electrically conductive material and a binder. It has sometimes been found advantageous to coat porous electrically conductive substrates with materials, such as carbon or graphite materials, in order to reduce porosity or achieve some other object. The material applied to the substrate is referred to herein as “loading material.” When loading material is applied to one side of a substrate to form a layer, the formed layer is frequently referred to as a “sublayer.” The amount of loading material (that is, the material eventually loaded onto the substrate) in a fluid diffusion layer or an electrode may be referred to as the “loading” of loading material and is usually expressed as the mass of material per unit surface area of substrate.

A certain loading of carbon or graphite can improve the operational performance of an electrode. However, if the loading is too high, performance is impaired by interference with diffusion of product or reactant through the fluid diffusion layer. Nonetheless, substrates having larger pores or a higher porosity tend to require higher loadings of carbon or graphite. Substrate having smaller pores or lower porosity may require lower loadings.

A substrate need not be highly electrically conductive and in fact may be an electrical insulator. Such substrates may be filled with electrically conductive materials. Electrodes which are made from filled, poorly electrically conductive webs and methods for making same are disclosed in U.S. Pat. Nos. 5,863,673 and 6,060,190, which are incorporated herein by reference.

A substrate for an electrode typically has a loading material applied to it in order to provide a surface for electrocatalyst, to improve conductivity, and/or to accomplish some other objective. The loading material can be applied by any of the numerous coating, impregnating, filling or other techniques known in the art. The loading material may be contained in an ink or paste that is applied to the substrate.

In a typical process for applying a loading material to a substrate, the substrate has an ink applied to it, where the ink comprises carbon and/or graphite with a poreformer and a binder in aqueous solution. After this application and before drying, the substrate and the loading material applied to the substrate may or may not be subjected to compaction at an elevated pressure, such as the pressure to which the electrode may be subjected in a fuel cell stack, or a higher pressure. The substrate and applied loading material are dried, with the result that the substrate is loaded to a greater or lesser extent with the loading material on its surface and/or within the voids, thus forming a fluid diffusion layer. The fluid diffusion layer is typically pretreated with a hydrophobic polymer and sintered before the electrocatalyst is applied. The final fluid diffusion layer is still permeable to fluid reactants.

Compaction has been used in processes of loading a material upon a substrate. Compaction of a wet coated porous substrate tends to push the loading material into the substrate.

A method of performing the compacting step has been done with a reciprocating press. The portion of substrate (and applied loading material) to be compacted is placed between two relatively flat surfaces. After positioning the substrate and loading material applied thereto, the two surfaces of the reciprocating press come together to compress that portion. This reciprocating press tends to increase production time, as it requires a continuous roll of substrate to stop and start for the compacting step. Furthermore, it is difficult to achieve a consistently flat surface, particularly since the surface tends to become soiled with loading material.

U.S. Pat. No. 5,732,463 relates to a method of making an electrode comprising the steps of cooling a weighed amount of catalyst below its critical temperature, grinding the catalyst to reduce its particle size, applying the ground catalyst to the surface of an electrode substrate, compacting the catalyst on the electrode surface, and sintering the catalyst. The compacting step is performed by passing the substrate and applied catalyst through two rollers. The applying step is performed in a batch manner and employs a controlled vacuum pressure for a long enough time so the catalyst is deposited or passed through the substrate.

U.S. Pat. No. 6,127,059 discloses a gas diffusion layer for use in a solid polymer electrolyte fuel cell that makes use of a membrane electrode assembly of the type in which a catalyst layer is formed on the surface of a solid polymer electrolyte membrane. The gas diffusion layer includes a carbon fiber woven cloth having a surface and a coating of fluororesin containing carbon black on the surface. The carbon fiber woven cloth may be pre-treated with a water-repellant fluororesin (such as polytetrafluoroethylene), or with a mixture of a fluororesin and carbon black, to enhance water repellency. In the examples, a dispersion for water repellency treatment was applied by immersion, and excess liquid was squeezed out of the carbon fiber cloth by nipping the cloth with rubber rollers.

Fluid diffusion layers have been made using release materials, such as Mylar release films or Saran Wrap separation films. In some cases, the release film has a loading material applied to one surface, and then a substrate is applied over the release film. This combination of substrate, loading material, and release film is dried and heated, after which the release sheet is peeled off. U.S. Pat. No. 6,127,059 discusses the use of a release sheet.

There is a need for improved methods of manufacturing fuel cells of consistent and high quality. It would be desirable to develop efficient, large-scale, commercial manufacturing processes, including such process for making fluid diffusion layers and electrodes. There remains a need for a low-cost, continuous, efficient method of compacting a substrate to which a loading material has been applied and/or a fluid diffusion layer to which an electrocatalyst has been applied.

An improved method of preparing a fluid diffusion layer or electrode is desired. An improved method of adhering a loading material to a substrate during preparation of a fluid diffusion layer or an electrocatalyst during preparation of a fluid diffusion electrode is also desired.

### SUMMARY OF THE INVENTION

A continuous method for preparing a fluid diffusion layer is provided. The fluid diffusion layer comprises a substrate and at least one loading material adhered to the substrate. The loading material is adhered to the substrate by the steps of continuously applying a loading composition comprising the loading material to the substrate, continuously compacting the substrate and the loading material applied thereto by applying pressure from at least one compaction roller, and drying the substrate and the loading composition applied thereto.

In the present methods, the substrate may be pretreated with a hydrophobic polymer before the step of continuously applying a loading composition to the substrate. The method may further comprise the step of sintering the fluid diffusion layer.

The method may further comprise the steps of continuously applying an electrocatalyst composition comprising at least one electrocatalyst to the fluid diffusion layer, continuously compacting the fluid diffusion layer and the electrocatalyst applied thereto by applying pressure from at least one roller (for example, by compacting the fluid diffusion layer and the electrocatalyst between two compaction rollers), and drying the fluid diffusion layer and the electrocatalyst composition applied thereto. The fluid diffusion layer and the electrocatalyst form an electrode.

A continuous method for preparing a fluid diffusion electrode is also provided. The electrode comprises a fluid diffusion layer and at least one electrocatalyst adhered to the fluid diffusion layer. The electrocatalyst is adhered to the fluid diffusion layer by the steps of continuously applying an electrocatalyst composition comprising the electrocatalyst to the fluid diffusion layer, continuously compacting the fluid diffusion layer and the electrocatalyst composition applied thereto by applying pressure from at least one compaction roller, and drying the substrate and the electrocatalyst composition applied thereto.

The present methods utilize compaction rollers for compacting a substrate and a loading material, and/or a fluid diffusion layer and an electrocatalyst. In the present methods, the substrate and the loading material, or the fluid diffusion layer and electrocatalyst, or both, may be compacted between two compaction rollers. The two compaction rollers may be separated by a predetermined gap. The two compaction rollers may apply a compacting pressure equivalent to at least 1 bar.

In the present methods, at least one compaction roller may be protected from soiling by disposing a separation film between the protected compaction roller and the loading material or the electrocatalyst. For example, a separation film may travel across the protected roller from a first reel to a second reel, whereby clean separation film is continuously disposed between the protected compaction roller and loading composition or electrocatalyst composition.

In the present methods, the substrate and the loading composition may be partially dried before the compacting step. For example, the loading composition may be partially dried to remove about 40% or less of the water. Similarly, a fluid diffusion layer and electrocatalyst composition may be partially dried before the compacting step.

The present methods may be used to increase and/or control the penetration of the loading material into the interior of the substrate, as opposed to having the loading material disposed entirely or excessively on the surface.

The method may also be used to increase and/or control the adhesion of the loading material to the substrate or the electrocatalyst to the fluid diffusion layer.

Further, the method may be used to improve surface uniformity of fluid diffusion layers and electrodes.

The present methods include effective and efficient ways to prepare fluid diffusion layers and electrodes. Where the present methods are used to adhere the loading material, the electrocatalyst layer will tend to have better penetration, adhesion and uniform distribution, even if the electrocatalyst is adhered by a technique other than the present methods.

### BRIEF DESCRIPTION OF THE DRAWING(S)

FIG. 1 is a schematic illustration of an embodiment of the present method.

### DETAILED DESCRIPTION OF PREFERRED EMBODIMENT(S)

The present methods may be employed to prepare fluid diffusion layers and/or electrodes, such as for use in a solid polymer electrolyte fuel cell. In some embodiments, the methods comprise applying one or more loading materials to a substrate and compacting the substrate and loading material(s) applied thereto between compaction rollers. In other embodiments, the methods comprise applying one or more electrocatalysts to a fluid diffusion layer and compacting the substrate and applied electrocatalyst(s) applied thereto, between compaction rollers. These embodiments may be used independently or together.

When referring to the substrate and the loading material or loading composition “applied thereto” or the fluid diffusion layer and the electrocatalyst or electrocatalyst composition “applied thereto”, it is contemplated that certain amounts of loading material, loading composition, electrocatalyst, or electrocatalyst composition which was applied in the applying step may be lost before compacting or drying as part of the normal losses associated with a manufacturing process. For example, when it is stated that the substrate and the loading composition applied thereto are compacted, it means that the substrate and applied loading composition remaining on the substrate, and not including loading composition or components thereof lost or removed as part of the process of preparing the fluid diffusion layer, are compacted.

In the present methods, the substrate may be any substrate suitable for use as part of a fluid diffusion layer. Generally, the substrate is a paper or board-like porous material and is a woven fabric, a non-woven fabric, or a mesh (a continuous sheet of substantially non-porous material that has been perforated). For example, an electrically-conductive material such as carbon cloth, carbon paper, carbon fiber woven, carbon fiber non-woven or graphite fiber nonwoven, is preferred. However, the substrate need not be electrically conductive if the loading material will impart adequate electrical conductivity for the resulting electrode.

The substrate is preferably flexible and otherwise suitable for processing in a reel-to-reel type process, such as where the substrate is unrolled from one reel, has a loading material applied to it, and later is rolled onto a second wheel (generally after other processing steps). Suitable flexible substrates include carbon or graphite paper, fabric-like tissue, woven carbon-fiber material, non-woven carbon-fiber material, felt or cloth, or composite material containing a particulate carbon-filler. Generally, the thickness of the substrate is in the range of about 50 to about 300 μm. The thickness of a fluid diffusion electrode made according to the present method is generally in the range of approximately 70 to 600 μm, with a thickness of approximately 200 μm being a preferred thickness.

Among the commercially available materials contemplated as the substrate in the present methods are carbon fiber non-woven webs available from SGL under the name SiGRACETT™ and available from Technical Fibre Products, Inc. Other suitable substrates are Zoltek cloth, and substrates available from Mitsubishi Rayon Corp. (MRC), Textron, and Freudenberg. Zoltek woven carbon fabric PW03 from Zoltek Corporation (St. Louis, Mo.) has been found suitable.

A hydrophobic polymer such as polytetrafluoroethylene (PTFE) is typically coated on the substrate to impart water repellency. The substrate may be pre-treated and then sintered to impart water repellency, for example, by applying a solution of a PTFE or other hydrophobic polymer to the substrate, allowing it to dry overnight at ambient room conditions, and then sintering it at temperatures of about 400° C. The substrate may be treated in this fashion to impart water repellency before any loading material is applied.

The loading material generally comprises electrically conductive material and preferably improves the conductivity of the electrode, reduces porosity, and reduces surface roughness. Preferred components of the loading material include carbon particles such as carbon blacks, graphite particles, boron carbide, and polymers. These and other particulate components of the loading material can be in various forms such as, for example, powders, flakes and fibers.

The loading material may further comprise electrocatalyst suitable for promoting the electrochemical reaction in the fuel cell. The loading material may comprise some or all of the electrocatalyst to be applied to the fluid diffusion layer to form an electrode.

Alternatively, the loading material may be totally free of electrocatalyst, such as where an electrocatalyst will be applied to a finished, sintered fluid diffusion layer to make an electrode or applied to the membrane at its interface with a fluid diffusion layer.

In still other embodiments, the loading material may comprise hydrophilic or hydrophobic components to alter the water transport characteristics of the electrode or portions thereof. Preferably, the loading material comprises a binder to bind particulate components of the loading material together and to retain the loading material in the substrate. Polytetrafluoroethylene is a suitable binder.

The loading material may be applied as part of a loading composition that is applied to a substrate. The loading composition typically comprises a carrier liquid such as water or other medium in which to suspend and/or dissolve the solids of the loading composition in order to make a suitable ink or paste for application to the substrate. The loading composition may also comprise any standard poreformer that does not interfere with the present method. A preferred poreformer is methylcellulose. The loading composition may also comprise a surfactant to aid in the penetration of the loading material into the substrate.

The loading material and the extent to which loading material is adhered to the substrate are selected so that the fluid diffusion layer is suitably, but not overly, porous and permeable to the fuel cell reactants and products, but has adequate electrical conductivity. For example, the completed fluid diffusion layer preferably retains porosity in the range of 60-90%.

Levels of loading material in a finished fluid diffusion layer may range from about 0.1 mg/cm² to about 4 mg/cm², although higher and lower loadings have been employed. In conventional techniques, higher loadings of loading material tend to decrease average surface roughness. However, higher loadings of loading materials also result in fluid diffusion layers having lower performance and increased expense.

In the present methods, the loading material is preferably adhered to the substrate in an average amount of about 4 mg/cm² or less, more preferably in an average amount of about 2 mg/cm² or less.

The loading composition preferably comprises carbon and/or graphite, a poreformer and a binder. The loading composition preferably has a solids content below 20 percent.

The applying step(s) may be performed in any of the known ways of coating, filling, or impregnating a substrate with a loading material. A preferred way to apply the loading material to the substrate is by using a knife coater or comma bar, which applies a predetermined thickness of material to a surface. Another way to apply the loading material is by screen-printing the loading material onto the substrate. Another way to apply the loading material is by passing the substrate through an immersion tank filled with the loading material.

A separation film may be used between the substrate/loading material and the compaction roller(s). The separation film may be any substance that is capable of protecting the roller from soiling during compaction of the wet and tacky loading composition yet remains easily removable such as by peeling. The use of a separation film during formation of the fluid diffusion layer may increase efficiency by eliminating or reducing the need to clean loading material from the rollers. Suitable separation films include Saran Wrap, Mylar sheet, Channeled Resources Blue R/L 41113 release film, and polyethylene coated paper.

The compacting step(s) may be performed using any suitable equipment having at least one roller. A preferred way is to compact the substrate, loading material and optionally a separation film between two compaction rollers. The compaction rollers may be made of hard coated solid aluminum or stainless steel, and preferably are chrome plated solid aluminum. The compacting step(s) should be done such that the substrate and loading material(s) are uniformly and evenly subjected to an equivalent compressive pressure of about 100 kPa (1 bar) or more as desired. This is typically accomplished by setting a suitable gap between the compaction rollers in accordance with the type of substrate and loading composition employed and with the compressive pressure desired. The gap is set such that the compacted substrate and loading material thickness is equivalent to that obtained at the desired compressive pressure.

The drying step(s) may be performed in any of the known ways. After compacting, the fluid diffusion layer may be dried to a moisture content of less than about 8%, alternatively of about 5%. To obtain a smoother product, the substrate and loading composition may be partially dried before compaction, preferably to remove about 40% or less of the moisture of the loading composition. Additionally, the fluid diffusion layers may be sintered by heat-treating at an elevated temperature, such as at a temperature from about 200° C. to about 420° C., and an electrocatalyst layer may be applied to the fluid diffusion layer to form an electrode.

The electrocatalyst may also be applied using the present continuous methods. An electrocatalyst composition typically comprises electrocatalyst, a solvent, a binder, and optionally ion exchange material.

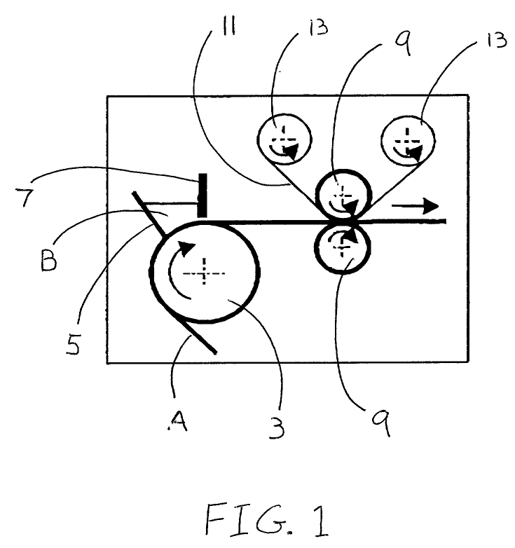

FIG. 1 generally shows apparatus suitable for performing the present methods. The apparatus comprises a knife coater for applying a loading composition and two compaction rollers for compacting the substrate and applied loading composition. The substrate A is fed in a continuous manner over a coating roll 3. As the substrate A passes over the top of the coating roll 3, a loading composition B comprising a loading material continuously is applied from a reservoir 5 to one surface of the substrate A with a knife coater 7. The knife coater 7 is typically adjustable so that a desired thickness of loading composition may be applied. The coated substrate is fed in a continuous manner (preferably at the same speed as it is fed through the knife coater 7) to two compaction rollers 9. The compaction rollers are preferably adjustable to a desired thickness so that a desired equivalent compressive pressure is applied to the substrate and applied loading composition.

In preferred embodiments, a separation film 11 is disposed between the coated surface of the substrate and at least one of the compaction rollers so that the loading composition does not contact or soil the compaction roller. For example, in FIG. 1, the separation film 11 travels from one reel to another reel across the top compaction roller 9, so that clean separation film continuously contacts the coated surface of the substrate. The separation film 11 travels between separation film rolls 13. Although it is not shown in FIG. 1, a second set of separation film rolls may be employed in connection with the other compaction roller, so that separation films are disposed between both of the compaction rollers and the substrate.

In other embodiments, the apparatus shown in FIG. 1 may be used to apply an electrocatalyst to a fluid diffusion layer. The reservoir may contain an electrocatalyst ink B, and a fluid diffusion layer A may be fed to the coating roller 3. In such embodiments, as the substrate A passes over the top of the coating roll 3, an electrocatalyst composition B continuously is applied from a reservoir 5 to one surface of the fluid diffusion layer A with a knife coater 7. The knife coater 7 is typically adjustable so that a desired thickness of loading composition may be applied. The coated fluid diffusion layer is fed in a continuous manner (preferably at the same speed as it is fed through the knife coater 7) to two compaction rollers 9. The compaction rollers are preferably adjusted so that a desired equivalent pressure is applied to the fluid diffusion layer and applied electrocatalyst thereby continuously compacting the fluid diffusion layer and applied electrocatalyst.

The present methods may reduce or eliminate the need for post-treatment steps. However, it may be desirable to use the present methods in connection with post-treatment steps, such as scraping with a blade, sanding, or corona treatment.

The present continuous methods are effective, efficient methods that use one or more rollers for a compacting step. In doing so, it is possible to improve and/or control penetration and adhesion and to achieve more uniform distribution of carbon and/or electrocatalyst on substrates and electrodes. The present methods are therefore appropriate for incorporation into an overall process for manufacturing fuel cells on a large-scale, commercial basis, and at a consistent and high level of quality. Notably, the reputation and goodwill of a fuel cell manufacturer that is able to efficiently produce sufficient quantities of fuel cells of consistent and high quality will be enhanced.

Although it is generally desirable to have the loading material primarily disposed at or near the surface of the substrate, it is desirable to have the loading material penetrate to the interior volume of the substrate to a certain degree. This is to increase conductivity and hydrophobicity and to reduce porosity. By using the present methods, one may control the degree of penetration of loading material into the interior of the substrate. For example, an equivalent compressive pressure of about 50 psi to about 400 psi should be used to get adequate penetration (in other words, penetration to ⅓ to ½ of the thickness). Alternatively, the equivalent pressure may be adjusted in response to some measured parameter, such as penetration thickness (which may for instance be inferred from the difference between the thicknesses of the coated and uncoated substrate). In this fashion, a balance between penetration and maintaining an adequate amount of loading material at or near the surface may be struck.

The present methods provide better adhesion of loading material to the substrate because the penetration can be controlled to the porosity of the substrate

Further, the present method curtails waste of raw materials, including polymer electrolyte membranes, substrates, loading materials, and electrocatalysts. By way of example, if an electrocatalyst coating that is applied to a fluid diffusion layer insufficiently penetrates, insufficiently adheres to or unevenly resides on the layer, a fuel cell into which the electrode is incorporated may not function properly or it may not function at all. Under such circumstances, the fuel cell may have to be scrapped or, if it has already been sold and placed into operation, it may have to be replaced.

A process to manufacture electrochemical fuel cells must be efficient in order to be commercially viable. The efficiency of a process can generally be measured by its throughput rate and the consistency and quality of the resulting products. The present methods, which are appropriate for incorporation into an overall fuel cell manufacturing process, may attain a throughput rate of 20 m/minute.

### EXAMPLE

In these examples, fluid diffusion layers were prepared according to the present methods. Carbon fiber woven materials sold under the name Zoltek PW03 were used as starting substrates. First, a continuous roll of substrate was immersed in a reel-to-reel fashion in a dilute solution of DuPont Polytetrafluoroethylene (PTFE) homopolymer Product 30B so that the substrate was soaked with this suspension. The soaked substrate was then squeezed between two rollers, then dried at 150° C. The substrates to be made into anodes or cathodes contained 18% by weight and 6% by weight, respectively, PTFE.

Next, loading compositions having three different viscosities were applied to the substrates to form fluid diffusion layers. In these examples, the loading compositions all comprised an emulsified mixture of Shawinigan acetylene carbon black, DuPont Polytetrafluoroethylene homopolymer Product 30B, and methyl cellulose. The solids content of loading composition was about 15% (by weight).

The various loading compositions were applied to the substrates using a comma bar and a suitable blade gap. The substrates and applied loading compositions were then compacted between two compaction rollers while wet (within about 5 seconds of coating) at an equivalent pressure of 1 bar (about 100 kPa). A saran separation film was employed as shown in FIG. 1 to prevent soiling of the compaction roller. The speed of the substrates through the compaction rollers was one meter per minute. The substrates were then dried at 150° C. and the final weight of PTFE and carbon in the dried fluid diffusion layers was about 2 mg/cm². Table 1 summarizes the differences between the samples made using three different loading composition viscosities.

TABLE 1

| Parameters | Example A | | Example B | | Example C | |
|---|---|---|---|---|---|---|
| Viscosity of | 2,000 | cps | 20 | cps | 800 | cps |
| Loading | | | | | | |
| Composition | | | | | | |
| Knife Gap | 0.7 | mm | 0.7 | mm | 0.6 | mm |

| | | | |
|---|---|---|---|
| Surface of FDL | Smooth | Not Smooth | Smooth |
| Build Up In | Yes | Yes | Less Build |
| Front Of | | | Up |
| Compaction | | | |
| Roller* | | | |

*Some loading material accumulates over time in the region between the web and separation film in front of the compaction roller.

The coated substrates were then sintered at 400° C. for about 2 minutes to render the layers hydrophobic and thus ready for use in an MEA or for application of an electrocatalyst.

Electrodes were then prepared from these fluid diffusion layers (FDLs). An electrocatalyst was applied to the same sides of the FDLs to which the loading material had been applied. That side was sprayed with an isopropyl/water mixture. While wet, an electrocatalyst composition was applied.

For these examples, the electrocatalyst compositions comprised carbon supported catalyst, Nafion and water. The anode catalyst was 20% by weight platinum and 80% by weight carbon. The cathode electrocatalyst composition was 40% by weight platinum and 60% by weight carbon. These catalysts may be obtained from Johnson Matthey. The platinum loading for the anode was 0.3 mg/cm₂, and the platinum loading for the cathode was 0.7 mg/cm₂. Both electrocatalyst compositions contained 23% by weight Nafion. After application, the materials were then dried at 50-80° C.

Fabrication of fluid diffusion electrodes ready for use in a solid polymer electrolyte fuel cell were then completed by applying a Nafion spray comprising 10% Nafion in a water/isopropyl alcohol mixture (prepared by adding 20% isopropyl alcohol to Nafion solution purchased from DuPont) to the catalyst coated surfaces and drying at 80° C. The Nafion loadings applied to the webs via this spray were both 0.2 mg/cm².

The present methods have shown particularly good results when a loading composition having a medium or high viscosity is used.

These examples demonstrate that a throughput of one meter per minute is attainable with the present methods.

These examples demonstrate that a larger knife gap tends to cause more build-up of loading composition at the compaction roller. In these examples, the loading composition preferably has a viscosity greater than 20 cps for better surface results. Higher web speeds tended to cause more build-up. A high binder content loading material (in other words, comprising 10% by weight or more binder) should be used to avoid separation of carbon, carbon powder and water at the compaction rollers.

Compared to reciprocating press compaction, the present methods are less time-consuming and therefore more efficient. More specifically, reciprocating press compaction is relatively time-consuming because it requires that a substrate roll is continuously started and stopped. The present methods are also more efficient than reciprocating press compaction because they are more effective than reciprocating press compaction. More specifically, it is difficult to create a surface that is flat enough to be used in a reciprocating press compaction process. Typically, an acceptably flat surface can be attained only by injecting or applying a compressive medium between the electrode substrate and the press. Such media serve to more evenly distribute the pressure that is used to apply loading materials and electrocatalyst. While use of such compressive media does improve the overall efficacy of reciprocating press compaction, reciprocating press compaction does not achieve the same degree of adhesion, penetration or uniform distribution as the present methods do.

The present methods provide electrodes of more consistent and higher quality and, as such, fuel cells of more consistent and higher quality.

The present methods avoid wasting materials and resources, and should enhance a fuel cell manufacturer's goodwill and reputation (through fuel cells of more consistent and higher quality). Cost savings (relative to other known methods) should also be realized from using the present method, and those savings are a major benefit of the present methods.

While particular steps, elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications as incorporate those steps or elements that come within the scope of the invention.

What is claimed is:

1. A continuous method for preparing a fluid diffusion layer comprising a substrate and at least one loading material adhered to the substrate, wherein the at least one loading material is adhered to the substrate by the steps of:
(a) continuously applying a loading composition comprising the at least one loading material to the substrate;
(b) continuously compacting the substrate and the loading material applied thereto by applying pressure from at least one compaction roller; and
(c) drying the substrate and the loading composition applied thereto.

2. The method of claim 1, wherein the compacting step is characterized by:
compacting the substrate and the loading material between two compaction rollers.

3. The method of claim 2, wherein the two compaction rollers are separated by a predetermined gap.

4. The method of claim 3, wherein the two compaction rollers apply compacting pressure equivalent to at least 1 bar to the substrate and the loading composition.

5. The method of claim 1, wherein the substrate is pretreated with a hydrophobic polymer before step (a).

6. The method of claim 1, further comprising:
(d) sintering the fluid diffusion layer.

7. The method of claim 6, further comprising:
(e) continuously applying an electrocatalyst composition comprising at least one electrocatalyst to the fluid diffusion layer;
(f) continuously compacting the fluid diffusion layer and the electrocatalyst applied thereto by applying pressure from at least one roller; and
(g) drying the fluid diffusion layer and the electrocatalyst composition applied thereto;
whereby the fluid diffusion layer and the electrocatalyst form an electrode.

8. The method of claim 7, wherein step (f) is characterized by:
compacting the fluid diffusion layer and the electrocatalyst between two compaction rollers.

9. The method of claim 1, further comprising the step of protecting at least one compaction roller from soiling by disposing a separation film between the protected compaction roller and the loading material.

10. The method of claim 9, wherein the separation film travels across the protected roller from a first reel to a second reel, whereby clean separation film is continuously disposed between the protected compaction roller and the loading material.

11. The method of claim 1, wherein the loading composition is applied to only one side of the substrate.

12. The method of claim 1, wherein the loading composition comprises a liquid.

13. The method of claim 12, wherein the liquid is water.

14. The method of claim 12, wherein the substrate and the at least one loading composition are partially dried before the compacting step.

15. The method of claim 14, wherein the loading composition is partially dried to remove about 40% or less of the water.

16. A continuous method for preparing a fluid diffusion electrode comprising a fluid diffusion layer and at least one electrocatalyst adhered to the fluid diffusion layer, wherein the at least one electrocatalyst is adhered to the fluid diffusion layer by the steps of:
(a) continuously applying an electrocatalyst composition comprising the at least one electrocatalyst to the fluid diffusion layer;
(b) continuously compacting the fluid diffusion layer and the electrocatalyst composition applied thereto by applying pressure from at least one compaction roller; and
(c) drying the substrate and the electrocatalyst composition applied thereto.

17. The method of claim 16, wherein step (b) is characterized by:
compacting the fluid diffusion layer and the electrocatalyst between two compaction rollers.

18. The method of claim 16, further comprising the step of disposing a separation film between the at least one compaction roller and the electrocatalyst.

19. The method of claim 18, wherein the separation film travels across the protected roller from a first reel to a second reel, whereby clean separation film is continuously disposed between the protected roller and the electrocatalyst.

20. The method of claim 16, wherein the fluid diffusion layer and the electrocatalyst composition are partially dried before the compacting step.
